(19) United States
(12) Patent Application Publication
(10) Pub. No.: US 2014/0150299 A1
(43) Pub. Date: Jun. 5, 2014

(54) CANINE PROTECTIVE BOOT

(71) Applicant: Therese Leigh Entler, Vancouver, WA (US)

(72) Inventor: Therese Leigh Entler, Vancouver, WA (US)

(21) Appl. No.: 13/691,769

(22) Filed: Dec. 1, 2012

(51) Int. Cl. A01K 13/00

(52) U.S. Cl. CPC A01K 13/007
USPC 36/111

(57) ABSTRACT

A canine boot for protecting the foot, lower leg, and dew claw, and preventing twisting, having ease of mounting on the canine's foot, good tactile feeling of the terrain underfoot, moisture and heat ventilation, and substantial protection for travel over rough and/or hazardous terrain particularly encountered by search and rescue, and service dogs.

### BACKGROUND OF THE INVENTION

1. Field of the Invention

The present invention generally relates to protective footwear for canines, more specifically to canine footwear with improved features for service dogs and rescue dogs, and yet more specifically to canine footwear that is easier to securely put on canine feet by visually impaired dog owners.

2. Description of the Related Art

Dogs have long been known as “man's best friend.” These animals serve very diverse functions, providing companionship, guarding, towing, hunting, and even sensory conversion, such as a seeing eye-dog, a hearing-assist dog, and even a police or military dog. Regardless of the relationship between person and dog, at various times, and for many diverse reasons, it may be highly desirable for the dog owner to place boots upon the dog's paws. Canine footwear has been developed to mitigate the discomfort that dogs may experience when standing, walking, or running on harsh terrain, such as hot pavement, snow or rough surfaces. For example, Seeing Eye dogs and other service dogs are often subjected to hot, sun-baked pavement surfaces for prolonged periods of time. This can cause burning, cracking and/or infection of the dog's foot pads. Canine footwear also provides dogs with protection from hazards such as thorns, burns, stinging insects, and salt used in street maintenance during wintery weather. These hazards can be particularly bothersome for dogs that spend a large amount of time indoors, because such dogs are unable to develop the tougher paw pads that dogs that spend a large amount of time outdoors have.

A number of artisans have recognized one or more of the foregoing needs, and so have designed various dog boots and socks. For example, U.S. Pat. No. 6,186,097 issued Feb. 13, 2001 to Brockmann et al teaches a protective covering in the form of a tube sock like paw and lower leg protector utilizing a pair of straps to mitigate the natural rotating and slipping off of the paw typical of a tube sock.

U.S. Pat. No. 4,967,542 issued Nov. 6, 1990 to MacDonald teaches a loafer like rear paw shoe to cover only the paw and secured to the rear paw by the fibular tarsal of the dog's leg. There is no protection for the dew claw or lower leg of the dog.

U.S. Patent Number 6,546,704 issued April 15, 2003 to Fisher teaches a dog shoe comprising a flexible, high friction surface material that wraps around the foot of a dog and secured in a closed position. There is not protection for the dew claw or lower leg of the dog and in addition there is no provision to prevent the twisting of the shoe on the dog's foot during use.

U.S. Patent Application Publications 2007/0039565 and 2007/0039566 both published on February 22, 2007 to Krottinger and both teaching a dog shoe designed like a human walking shoe with heavy sole, laces, elastic straps to allow the dog's foot to enter the shoe and an ankle strap to hold the shoe upper around the dog's lower leg. Again there is no lower leg, dew claw protection and the mounting of the shoe is cumbersome especially for a blind person.

U.S. Patent Application Publications 2005/0188925 published September 1, 2006 and 205/0241188 published November 3, 2005 both to Yun et al. teach a dog shoe having a sole and an upper with a front zipper running from toe to upper top edge having a tongue to protect the foot from irritation by the zipper. Further having an elastic ankle cinch mounted in the upper portion of the shoe wall. There is no dew claw or lower leg protection and mounting the shoe can be difficult especially for a blind or otherwise handicapped dog owner. Other similar style dog boots which include lower leg and dew claw protection are, for example, U.S. Pat. No. 6,526,920 issued Mar. 4, 2003 to Griffin; U.S. Pat. No. 5,148,657 issued Sep. 22, 1992 to Stafford et al; U.S. Pat. No. 5,1008,812 issued Apr. 25, 1995 to Stark; U.S. Pat. No. 8,49,241 issued Feb. 7, 2012, U.S. Patent Application Publications 2007/0044734 published Mar. 1, 2007 and 2012/0132143 published May 31, 2012 all to Maloney et al.

U.S. Pat. No. 7,971,557 issued Jul. 5, 2011 and U.S. Pat. No. 8,113,152 issued Feb. 14, 2012 as well as U.S. Patent Application Publication 2011/0265733 published Nov. 3, 2011 all to Paxton et al. teach a dog sock like boot comprising a breathable substrate having various other materials are attached and the boot is secured to the dog's foot by a pair of tensioning straps acting in conjunction with strategically located cushions. The boot upper portion contains slits to allow for a securing to the dog's lower leg. Mounting this boot requires the use of two tensioning straps and a plurality of cushions to provide proper fit as well as care to prevent bunching of said cushions against the dog's leg.

However, these prior art boots tend to suffer from several common limitations. As may be recognized, related art dog boots are often very difficult to put on the dog's foot. This problem will be intensified by the fact that most dogs will not remain still while a person is trying to put the boot on, especially by a person of limited or no sight. Once on, several of these prior art boots do not stay on well. Some will simply spin about, potentially causing much discomfort or harm to the dog. Others will slide off as the dog walks or runs, much like loose sock coming off of a person walking on carpet. This phenomenon is quite significant, since the boot must be designed to be of non-slip material, or the dog will sprawl on finished wood, icy or other relatively slippery surfaces. Yet the boot must also preferentially stay on the dog's paw, rather than slide with respect thereto, even when the booted dog is traversing terrain having good traction. Simply applying more force about the dog's leg to keep the boot on has proven to be totally unsatisfactory, since circulation within the leg may become limited or disrupted. Unintended bunching of the boot top can be harder to detect, and can also restrict circulation. Yet, different dogs will have significantly different proportions between pad size and leg diameter, meaning that the boot must be very adjustable to accommodate different dog breeds and sizes. Many of these related art boots have heavy soles which reduce or prevent the dog from having tactile feedback of the terrain the dog is traversing making walking and running more difficult for and dangerous to the dog. Finally, complex boots are not only more difficult to put on the dog, especially by visually impaired persons, but they are also much more expensive to produce, which is also undesirable.

Thus, there remains a need for a dog boot that provides protection to foot pads and dew claws that is easy to put on the dog especially for the blind or visually handicapped, provides good tactile feedback to the dog about the terrain it is traversing, and doesn't nick, bunch, or twist while in use.

### DISCLOSURE OF THE INVENTION

The present invention provides advantages and alternatives over the prior art by providing a canine protective boot that provides protection for the foot, lower leg, and dew claw while allowing the canine excellent tactile sense of the terrain underfoot.

According to a further aspect of the present invention, there is provided a canine protective boot that is easy to mount even by those visually handicapped or blind.

According to yet another aspect of the present invention provides for mounting of the boot quickly helping to alleviate canine nervousness and unease during boot mounting.

According to a yet further aspect of the present invention there is provided a canine protective boot that is well ventilated against overheating and moisture retention within the boot while also insulating the canine from ambient hot and cold conditions underfoot.

According to still another aspect of the present invention there is provided a canine protective boot providing foot, lower leg, and dew claw protection as well as heat and moisture ventilation and ease of mounting comprising in cooperative combination: a substantially tubular body having a first open end and a second closed end, the body further comprising an upper portion having a plurality of at least one non-slip fabric panel preventing twisting of said canine protective boot while in use and further having a buttonhole suitable for the integral securing strap to pass through to secure said canine protective boot to said canine's foot; said tubular body upper portion comprising an air and moisture breathable flexible tri-laminate material bonded to a web-like fabric; said sole portion exterior surface comprising an first sole waterproof tactile flexible sole material, a waterproof insulating tactile flexible second sole material, and an interior surface comprising a tri-laminate material, all bonded into a single composite layer; an integral securing strap securable around the periphery of said first open end of said substantially tubular body and being an extension thereof; and a means of securing and releasing said securing strap; thereby creating a desired canine protective boot having ease of mounting and suitable for protecting the foot, lower leg, preventing boot twisting, and dew claw of a canine while providing said canine with a tactile sense of the terrain being traversed as well as thermal insulation and moisture ventilation.

According to still yet another aspect of the present invention there is provided a canine protective boot providing foot, lower leg, and dew claw protection as well as heat and moisture ventilation and ease of mounting comprising in cooperative combination: a substantially tubular body having a first open end and a second closed end, the body further comprising an upper portion having a plurality of at least one non-slip fabric panel preventing twisting of said canine protective boot while in use and further having a buttonhole suitable for the integral securing strap to pass through to secure said canine protective boot to said canine's foot; said tubular body upper portion comprising an air and moisture breathable flexible tri-laminate material bonded to a web-like fabric; said buttonhole having a buttonhole periphery liner mounted around the periphery thereof; said sole portion exterior surface comprising an first sole waterproof tactile flexible sole material, a waterproof insulating tactile flexible second sole material, and an interior surface comprising a tri-laminate material, all bonded into a single composite layer; an integral securing strap securable around the periphery of said first open end of said substantially tubular body and being an extension thereof; and a means of securing and releasing said securing strap; thereby creating a desired canine protective boot having ease of mounting and suitable for protecting the foot, lower leg, preventing boot twisting, and dew claw of a canine while providing said canine with a tactile sense of the terrain being traversed as well as thermal insulation and moisture ventilation.

The present invention thus advantageously provides a canine boot that provides a high degree of foot, lower leg, and dew claw protection having good moisture and heat ventilation along with good sole insulation against extreme ambient conditions underfoot particularly for service and rescue canines coupled with an ease and speed of installation suitable for even the visually handicapped and the blind.

### BRIEF DESCRIPTION OF THE DRAWINGS

FIG. 1 shows a plan front/top view of a preferred embodiment of the claimed invention

FIG. 2 shows a plan back/bottom view of the preferred embodiment of the claimed invention of FIG. 1.

FIG. 3 shows a perspective top view of the preferred embodiment of the claimed invention of FIG. 1 in the process of being secured as on a canine foot.

FIG. 4 show a perspective top view of the preferred embodiment of the claimed invention of FIG. 1 in the secured condition as on a canine foot.

FIG. 5 shows a canine with the preferred embodiment of the claimed invention of FIG. 1 mounted on all four feet of said canine

### DESCRIPTION OF THE PREFERRED EMBODIMENTS OF THE INVENTION

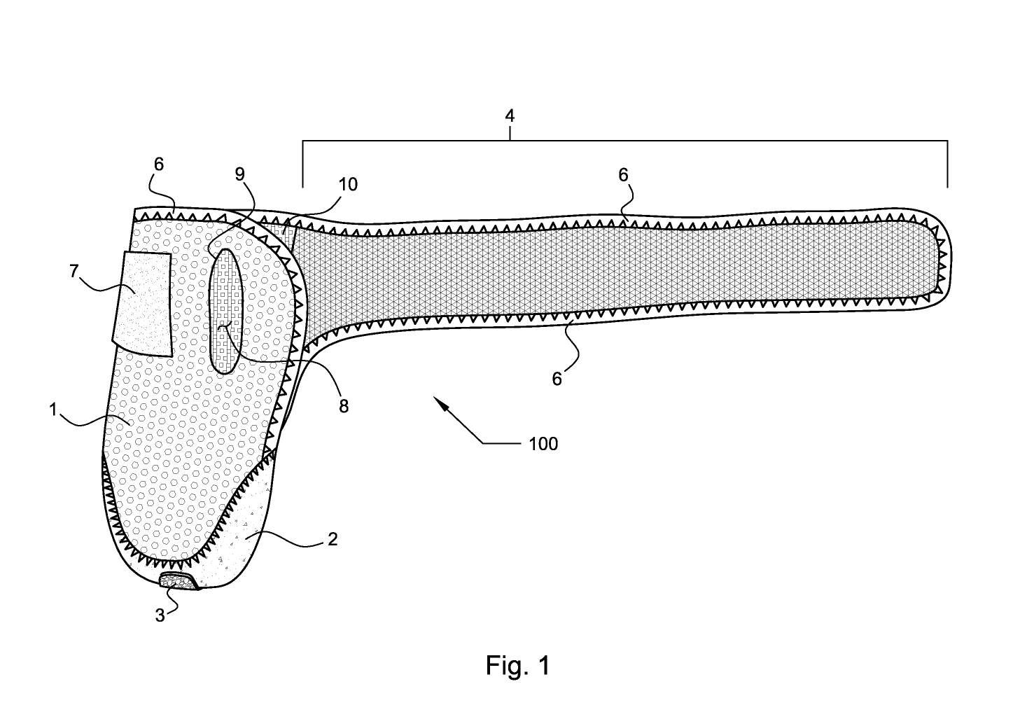

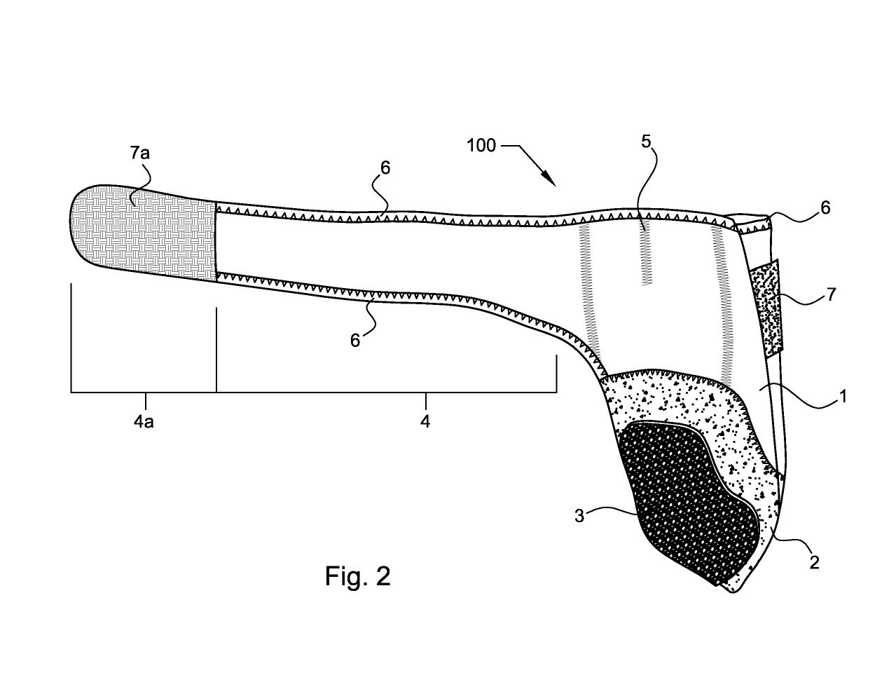

Reference will now be made to the drawings, wherein to the extent possible like reference numerals are utilized to designate like components throughout the various views. Referring to FIG. 1, which presents a plan front or top view of one preferred embodiment comprising a canine protective boot 100 having an upper portion 1 with at least one securing means 7 thereon (preferably a UBC loop fabric), a sole portion 2 comprising a waterproof durable flexible material and an outer sole portion 3 covering a substantial portion of said sole 2 and comprising a waterproof, wear and damage resistant durable flexible material. Said outer sole 3 being more abrasion resistant and of a more substantial composition than sole portion 2. Further, said outer sole 3 is configured to be foot pad compatible to provide for a more natural feel to the canine and provide a better feel for the terrain under the canine's foot. As further shown in FIG. 1, there is an integral securing strap portion 4 of said upper portion 1, and an edge sealing means 6 covering the exposed edges of said canine protective boot upper portion 1 and said integral securing strap portion 4. Further, said integral securing strap portion 4 from said boot upper portion 1 has a smooth faced Lycra fabric bonded to the outer face of said securing strap portion 4 comprising a web-like synthetic fabric 5 (see FIG. 2). The presently preferred sole portion 2 and outer sole portion 3 materials have a tactile outer surface that provides a sense of sure-footedness allowing the pet to walk comfortably and stably on a multitude of surfaces. This is further enhanced by said outer sole portion 3 being designed to substantially mimic the foot pad conformation of the canine As also shown in FIG. 1, is a buttonhole 8 the periphery 9 of which may also have a stiffening agent to assist in keeping said buttonhole 8 open. Buttonhole is used in the commonly accepted way meaning a bore through a relatively thin material where said bore periphery is either raw material, finished by known buttonhole techniques, or stiffened/lined and finished by known buttonhole techniques. This is particularly helpful for securing said canine boot with one hand and/or by a blind person. Preferably this stiffening agent is a semi-rigid polymeric material encased in protective fabric, said fabric being the same or different than the fabric of said protective boot upper portion 1. The presently preferred material is Lycra fabric with a smooth surface. It is also preferred, though not critical, that this Lycra fabric surface comprises the inside surface of the sole portion 2, although a separate material known in the art may be utilized if desired. Finally there is shown a non-slip fabric 10 located on the interior surface of the upper rear portion of upper portion 1 to assist in preventing twisting of the boot 100 on the canine's foot when in use.

As further shown in FIG. 1 the boot upper portion inner surface and the inner body portion of said securing strap 4 upper surface comprises said Lycra fabric surface bonded to the exterior surface comprising a synthetic web-like material.

Referring now to FIG. 2, there is shown a plan back or bottom view of the preferred embodiment of FIG. 1 having a canine protective boot 100 having an upper portion 1, a sole portion 2, and outer sole portion 3, integral securing strap portion 4 comprising a web-like synthetic fabric body portion 4 and an end portion 4a comprising securing means 7a (preferably an engineered molded hook fastener material), a plurality of at least one darts 5, and an edge sealing means 6 covering the exposed edges of said canine protective boot upper portion 1 and said integral securing strap portion 4. Outer sole portion 3 is designed to be pad specific thereby providing a natural feel of surfaces and offers better traction for the canine's foot. Also shown is one securing means 7 comprising preferably a UBC loop fabric.

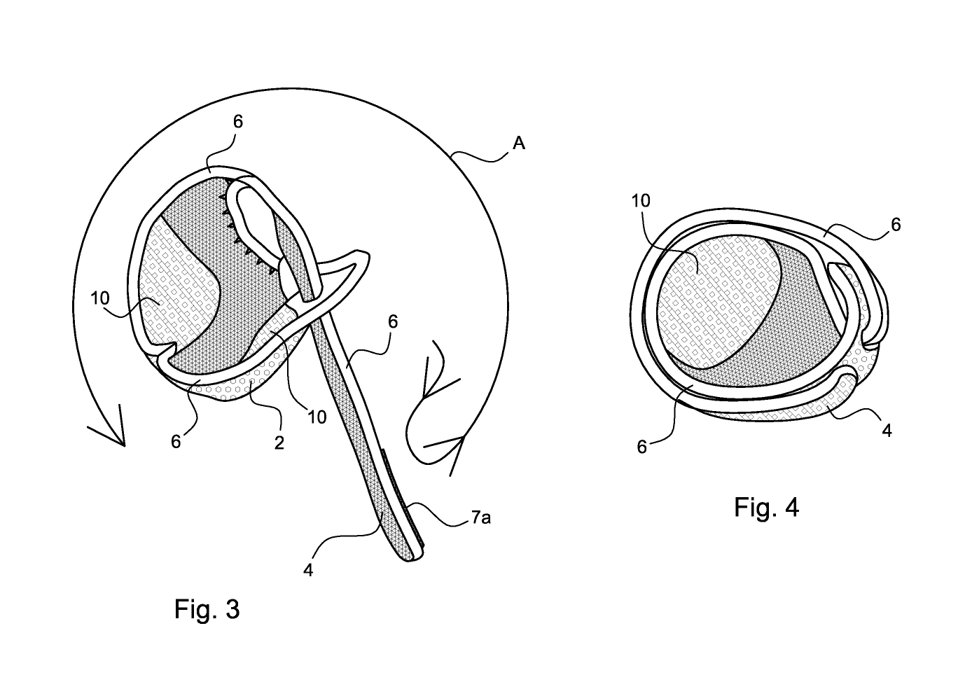

Turning now to FIGS. 3 there is shown a top plan view of the preferred embodiment of FIG. 1 in an open condition as the boot 100 would be immediately after placing it on a canine's foot and the securing strap portion 4 has been inserted through buttonhole 8 (see FIG. 1) ready to be secured around boot upper portion 1 (see FIG. 1) thereby securing said boot 100 onto said canine's foot. The arrow A, indicating the route of said strap portion 4 during securing. Also shown are edge sealing means 6 covering the exposed edges, sole portion 2, securing strap 4 end portion having complimentary securing portion 7a, non-slip fabric 10 sections on the front and rear interior portions of said boot 100 preventing movement of said boot 100 in relation to the canine's foot mounted therein, and securing means 7a.

Referring now to FIG. 4, there is shown a top plan view of the preferred embodiment of FIG. 1 in a closed condition as it would be once secured on a canine's foot. Here the securing strap portion 4 is fully wrapped around the boot 100 upper portion 1 (see FIG. 1) and secured to said boot 100 upper portion 1 (see FIG. 1) by securing means 7a (see FIG. 3). Also shown is non-slip fabric 10 on the rear interior of said boot 100 providing movement prevention between the canine's foot and said boot 100.

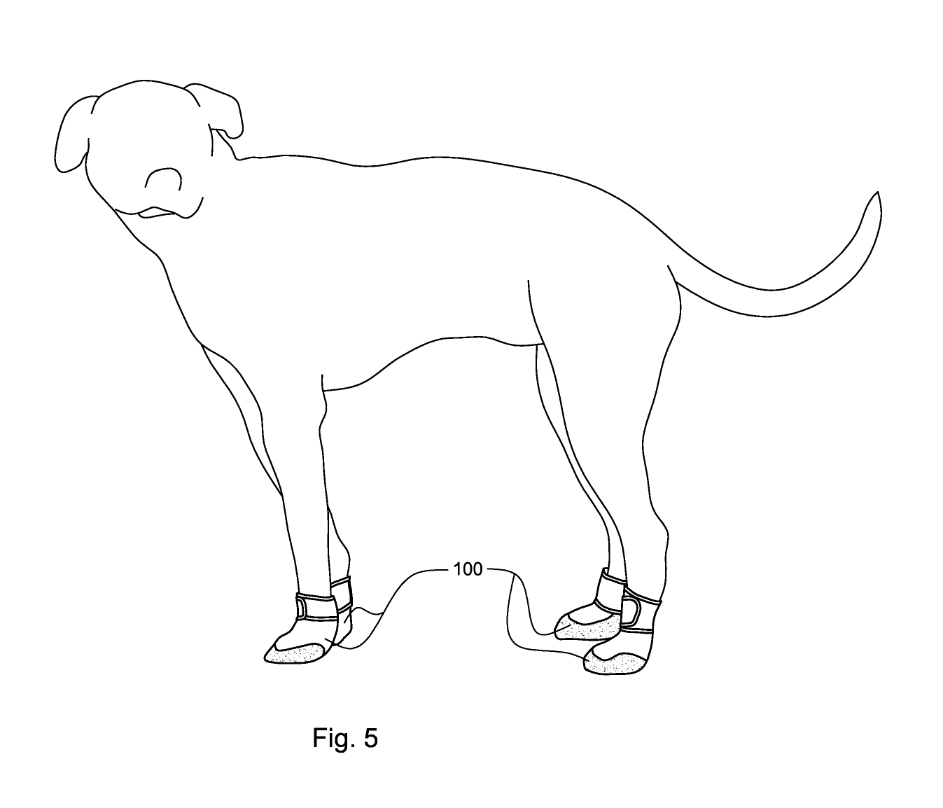

Referring now to FIG. 5, there are shown four canine boots 100 of the preferred embodiments of FIG. 1 mounted on the four feet of a canine It is to be understood that there are distinct left foot boots and right foot boots for better and more secure fit as well as preventing the securing means from a first boot locking to the securing means of a second boot while worn by a canine

As previously set forth, the canine protective boot of the claimed invention is constructed of materials selected for their ability to provide ventilation of heat and moisture, to securely mount the boot in an easy and efficient manner, allow for easy removal of said boot, provide protection for the canine's feet, lower legs, and dew claws, and superior tactile feedback to the canine of the terrain it is traversing while protecting the canine from bruising, cuts, and other injury. With those considerations and other in mind the presently preferred upper portion 1 material is one that promotes the transfer of air and moisture the canine's foot and lower leg. Presently preferred is the Breath-O-prene brand tri-laminate material, as disclosed in U.S. Pat. No. 6,861,379 incorporated herein by reference, from AccuMED Technologies of Buffalo, N.Y. More preferred is a Breath-O-prene material having a nylon spandex blend fabric on one surface and an unbroken loop (UBL) fabric on the other side with an open cell polyurethane center layer bonded to a web-like fabric having tackiness suitable to prevent slipping when against the canine's foot or the terrain surface. Presently particularly preferred is the web mesh fabric PUBSI MESHLER by Mogae Fabric Co. The presently preferred securing means 7 is hook and loop tape particularly Velcro brand from Velcro USA of Manchester, N.H. Especially preferred is Velcro Industries, ULTRA-MATE® brand or ACCUMED fabric products comprising engineered molded hook fasteners which provide superior closure with a variety of loops low profile knit loops, 900 hooks per square inch, a hook height of 0.028 inches, and standard hooks: 805, 811, and 845.The preferred first sole material 2 is flexible, waterproof, physically tough and sturdy comprising Toughtek; a waterproof PVC copolymer coated polyester fabric as the outer surface from Harrison Technologies of Broadalbin, N.Y. The presently preferred second outer sole material 3 is either PU synthetic Leather Embossed or TOPY Vulkosoft PU. The buttonhole 8 periphery 9 may or may not have a stiffening liner, which when present is preferably a semi-rigid polymeric material. Presently preferred is thin sheet elastomer. The presently preferred elastic binding tape 6 is made by Paiho Ltd and is a Nylon and Spandex fabric. The presently preferred interior slip resistant material 10 is a woven poly fabric with a PVC coating from Kittrich LLC sold as Vantage Non Slip Fabric. It is to be appreciated that the manner of attachment of the various components to one another may be by any suitable well known method, such as, for example, adhesives, heat welding, sewing, and the like. It is further to be appreciated that while the present invention provides flexibility in fitting to various sized animal feet this can be further enhanced as to fit and comfort by providing a variety of physical sizes of said claimed invention. Where various components of the present invention are preferably sewn together, said sewing is done using nylon or Dacron thread using well known techniques in the sewing arts. Where various components are adhesively bonded the presently preferred adhesive is Adhesive style #3206 manufactured by Bemis Associates of Shirley, Mass.

In practice the open canine boot 100 is placed on the desired foot of a canine and pulled into the desired position. Then the securing strap portion 4 is inserted through the buttonhole 8 for the back or inside of the upper portion 1 of said canine boot 100. Next the securing strap portion 4 is drawn through said buttonhole 8 until the desired amount of pressure around said boot upper portion 1 is realized. Finally said securing strap portion 4 is secured to the upper portion 1 of said canine boot 100 by securing means 7. See arrow A indicating the travel path of said securing strap portion 4. It is to be noted that there are distinct right foot and left foot boots which provides optimum dew claw protection such that the strap tension falls on the outside of the leg not pressing against the dew claw. Further, this provides for the ends of the strap 4 to be orientated to the outside of the leg preventing accidental locking of a right and a left boot together thereby hobbling the canine Additionally, the height of the boot is designed to land right above the dew claw thereby again protecting it from injury.

Although the preferred embodiments of the present invention has been disclosed, various changes and modifications may be made without departing from the scope of the invention as set forth in the appended claims.

What is claimed is:

1. A canine protective boot providing foot, lower leg, and dew claw protection as well as heat and moisture ventilation and ease of mounting comprising in cooperative combination:
a substantially tubular body having a first open end and a second closed end, the body further comprising an upper portion having a plurality of at least one non-slip fabric panel preventing twisting of said canine protective boot while in use and further having a buttonhole suitable for the integral securing strap to pass through to secure said canine protective boot to said canine's foot;
said tubular body upper portion comprising an air and moisture breathable flexible tri-laminate material bonded to a web-like fabric;
said sole portion exterior surface comprising an first sole waterproof tactile flexible sole material, a waterproof insulating tactile flexible second sole material, and an interior surface comprising a tri-laminate material, all bonded into a single composite layer;
an integral securing strap securable around the periphery of said first open end of said substantially tubular body and being an extension thereof; and
a means of securing and releasing said securing strap;
thereby creating a desired canine protective boot having ease of mounting and suitable for protecting the foot, lower leg, preventing boot twisting, and dew claw of a canine while providing said canine with a tactile sense of the terrain being traversed as well as thermal insulation and moisture ventilation.

2. The canine protective boot as claimed in claim 1 wherein, said substantially tubular body comprises a nylon spandex blend fabric on one surface and an unbroken loop (UBL) fabric on the other side with an open cell polyurethane center layer bonded to a web-like fabric.

3. The canine protective boot as claimed in claim 1 wherein, said first sole portion comprises flexible, waterproof, physically tough and sturdy comprising a PVC copolymer coated polyester fabric.

4. The canine protective boot as claimed in claim 1 wherein, said second sole portion comprises one of the group consisting of a PVC coated woven polyester fabric and a polyurethane sheet material.

5. The canine protective boot as claimed in claim 1 wherein, said integral securing strap comprises the same material as said substantially tubular body.

6. The canine protective boot as claimed in claim 1 wherein, said means of securing said integral securing strap comprises engineered molded hook fasteners which provide superior closure with a variety of loops low profile knit loops, 900 hooks per square inch, a hook height of 0.028 inches, and standard hooks: 805, 811, and 845.

7. The canine protective boot as claimed in claim 1 wherein, said a non-slip fabric panel comprises flexible, waterproof, physically tough and sturdy comprising a PVC copolymer coated polyester fabric.

8. A canine protective boot providing foot, lower leg, and dew claw protection as well as heat and moisture ventilation and ease of mounting comprising in cooperative combination:
a substantially tubular body having a first open end and a second closed end, the body further comprising an upper portion having a plurality of at least one non-slip fabric panel preventing twisting of said canine protective boot while in use and further having a buttonhole suitable for the integral securing strap to pass through to secure said canine protective boot to said canine's foot;
said tubular body upper portion comprising an air and moisture breathable flexible tri-laminate material bonded to a web-like fabric;
said buttonhole having a buttonhole periphery liner mounted around the periphery thereof;
said sole portion exterior surface comprising an first sole waterproof tactile flexible sole material, a waterproof insulating tactile flexible second sole material, and an interior surface comprising a tri-laminate material, all bonded into a single composite layer;
an integral securing strap securable around the periphery of said first open end of said substantially tubular body and being an extension thereof; and
a means of securing and releasing said securing strap;
thereby creating a desired canine protective boot having ease of mounting and suitable for protecting the foot, lower leg, preventing boot twisting, and dew claw of a canine while providing said canine with a tactile sense of the terrain being traversed as well as thermal insulation and moisture ventilation.

9. The canine protective boot as claimed in claim 8 wherein, said substantially tubular body comprises a nylon spandex blend fabric on one surface and an unbroken loop (UBL) fabric on the other side with an open cell polyurethane center layer bonded to a web-like fabric.

10. The canine protective boot as claimed in claim 8 wherein, said first sole portion comprises flexible, waterproof, physically tough and sturdy comprising a PVC copolymer coated polyester fabric.

11. The canine protective boot as claimed in claim 8 wherein, said second sole portion comprises one of the group consisting of a PVC coated woven polyester fabric and a polyurethane sheet material.

12. The canine protective boot as claimed in claim 8 wherein, said integral securing strap comprises the same material as said substantially tubular body.

13. The canine protective boot as claimed in claim 8 wherein, said means of securing said integral securing strap comprises engineered molded hook fasteners which provide superior closure with a variety of loops low profile knit loops, 900 hooks per square inch, a hook height of 0.028 inches, and standard hooks: 805, 811, and 845.

14. The canine protective boot as claimed in claim 8 wherein, said a non-slip fabric panel comprises flexible, waterproof, physically tough and sturdy comprising Toughtek a PVC copolymer coated polyester fabric.
